(19) United States
(12) Patent Application Publication
(10) Pub. No.: US 2025/0268236 A1
(43) Pub. Date: Aug. 28, 2025

(54) MOBILE AUTONOMOUS PET CARE SYSTEM FOR LONG-TERM CARE OF PETS

(71) Applicants: Qixu Cao, Gainesville, VA (US); Owen Cao, Gainesville, VA (US); Kaylynn Cao Wu, Gainesville, VA (US)

(72) Inventors: Qixu Cao, Gainesville, VA (US); Owen Cao, Gainesville, VA (US); Kaylynn Cao Wu, Gainesville, VA (US)

(21) Appl. No.: 18/585,055

(22) Filed: Feb. 23, 2024

(51) Int. Cl. A01K 29/00; B25J 5/00

(52) U.S. Cl. CPC A01K 29/005; B25J 5/007

(57) ABSTRACT

The present invention discloses a Mobile Autonomous Pet Care System with an adjustable Main Chamber for seamless indoor and outdoor transition, catering to pets of varied sizes. Equipped with integrated subsystems for essential care tasks, the system facilitates watering, feeding, waste management, temperature control, exercise, and play, all while ensuring the pet's comfort and safety. A Remote Monitoring and Control Subsystem allows owners to maintain contact and manage care settings from afar. The Power Subsystem supports energy sustainability, drawing from solar panels, batteries, or generators. Additionally, the Main Chamber is fitted with a Wheel Platform, enhancing portability with a secure locking feature for safe and easy relocation. This system aims to enhance the quality of life for pets and provide peace of mind for owners, ensuring pets are well-cared for in a safe, engaging, and controlled environment.

### CROSS-REFERENCE TO RELATED APPLICATIONS

This application claims priority to U.S. Provisional Application No. 63/448,301 filed Feb. 26, 2023, which is hereby incorporated herein by reference.

### FIELD OF THE INVENTION

The present disclosure relates generally to pet care technologies. More specifically, the present disclosure describes systems and methodologies for a Mobile Autonomous Pet Care System devised to provide comprehensive, automated care for pets. This system integrates flexible housing, feeding, watering, waste management, temperature control, exercise, and monitoring functionalities to ensure the well-being of pets in the absence of their owners.

### BACKGROUND OF THE INVENTION

The present invention relates to a mobile autonomous pet care system designed to address the needs of pet owners confronted with the necessity of leaving their pets unattended for prolonged periods, owing to work commitments, travel engagements, or other responsibilities. Leaving pets unattended can cause anxiety and unease for both the pet and the owner. Regular feeding, exercise, and social engagement, essential for pets' well-being, may prove challenging to maintain in the absence of the owner. This system offers pets a secure, nurturing, and engaging atmosphere while enabling pet owners to remotely monitor and interact with their pets.

Pet trailers in the current state of art provide a means of transporting pets from one location to another. However, they lack the mobility to conveniently move between indoor and outdoors locations, which may be necessitated by changes in weather, travel exigencies, or other circumstances. These trailers also lack the automation in essential functionalities such as feeding, waste management, security, and monitoring, thus falling short of providing modern conveniences.

There is a need for a mobile autonomous pet care system capable of seamless transition between indoor and outdoor environments, and providing contemporary comfort and convenience for the pet.

### SUMMARY OF THE INVENTION

The present invention is a mobile autonomous pet care system that can be easily moved between indoor and outdoor locations, and provides modern comforts or conveniences for the pet.

The system comprises a main chamber and a wheel platform. The chamber has a feature of adjustable size configuration to facilitate seamless transition between indoor and outdoor settings, accessible via various entry points such as front and back doors. Additional subsystems can be attached to the main chamber to augment its functionalities. The wheel platform allows the main chamber to be easily attached for transfer between indoor and outdoor, or other designated locations.

The main chamber includes a plurality of subsystems that address the diverse needs of pets, comprising: Feeding System, Watering System, Waste Management, Exercise and Play, Temperature Control System, Security System, and Remote Monitoring and Control System for modern comfort and convenience for the pet.

### BRIEF DESCRIPTION OF THE DRAWINGS

Referring particularly to the drawings for the purpose of illustration only and not limitation, there is illustrated:

FIG. 1 provides a schematic diagram of the Mobile Autonomous Pet Care System according to one or more embodiments of the present invention.

FIG. 2 is a schematic representation illustrating the transformative capability of the main chamber of the present invention, depicting its adjustable structure from initially rectangular to a parallelogram, to facilitate passage through varying spatial constraints.

FIG. 3 is a top plan view of the present invention's main chamber, illustrating a shape transformation. Main chamber 300, initially circular, is reconfigured into main chamber 305, an elliptical shape.

FIG. 4 illustrates a schematic representation of a reconfigurable Main Chamber in two states, according to one or more embodiments of the present invention, demonstrating the chamber's ability to adapt its size for transport or space efficiency.

FIG. 5 illustrates the Watering Subsystem of the Mobile Autonomous Pet Care System, as integrated within the Main Chamber.

FIG. 6 illustrates the Feeding Subsystem of the Mobile Autonomous Pet Care System, as integrated within the Main Chamber.

FIG. 7 illustrates the Waste Management Subsystem of the Mobile Autonomous Pet Care System, as integrated within the Main Chamber.

FIG. 8 illustrates the Temperature Control Subsystem of the Mobile Autonomous Pet Care System, as integrated within the Main Chamber.

FIG. 9 illustrates the Security and Monitoring Subsystem of the Mobile Autonomous Pet Care System, as integrated within the Main Chamber.

FIG. 10 illustrates the Remote Monitoring and Control Subsystem of the Mobile Autonomous Pet Care System, as integrated within the Main Chamber.

FIG. 11 illustrates the Exercise and Play Subsystem of the Mobile Autonomous Pet Care System, as integrated within the Main Chamber.

FIG. 12 illustrates the Power Subsystem of the Mobile Autonomous Pet Care System, as integrated within the Main Chamber.

FIG. 13 presents an exemplary view of a mobile unit within the Mobile Autonomous Pet Care System with a wheel platform, depicting the unit with an extended solar panel array.

FIG. 14 depicts an exemplified side view of the mobile unit of the Mobile Autonomous Pet Care System with a wheel platform.

FIG. 15 depicts an exemplified side view of the mobile unit of the Mobile Autonomous Pet Care System, showcasing a vintage look complete with a wheel system.

FIG. 16 depicts an exemplified side view of the mobile unit of the Mobile Autonomous Pet Care System, featuring a vintage aesthetic complete with an integral wheel system.

Unless otherwise specifically noted, articles depicted in the drawings are not necessarily drawn to scale.

### DETAIL DESCRIPTIONS OF THE INVENTION

The foregoing descriptions of specific embodiments of the current invention, as represented in the drawings, are intended for the purpose of illustration rather than limitation. It should be understood that these embodiments are presented solely as examples of the myriad ways in which the fundamental principles of the invention may be applied. Modifications and variations that are readily apparent to those skilled in the relevant art are considered to fall within the broad spirit and scope of the invention, as defined by the subsequent claims.

The system comprises a main chamber and a wheel platform.

### 1. Main Chamber

### 1.1 Main Chamber Structure and Features

The main chamber is designed to have adjustable sizes and shapes to accommodate different types and sizes of pets to facilitate easy movement through different entrances, including standardized residential and commercial doorways. The main chamber can be designed to be made of detachable panels that may be easily removed and reattached. The main chamber may incorporate hinged panels that are capable of folding inwards, thereby enabling the enclosure to be compressed for passage through narrow openings commonly found in domestic and commercial settings. The main chamber may also be made with flexible materials, such as mesh or fabric, which can be deformed temporarily to fit through constrained spaces while still maintaining the integrity and security required for pet containment. Also the main chamber provides the housing for attaching different subsystems.

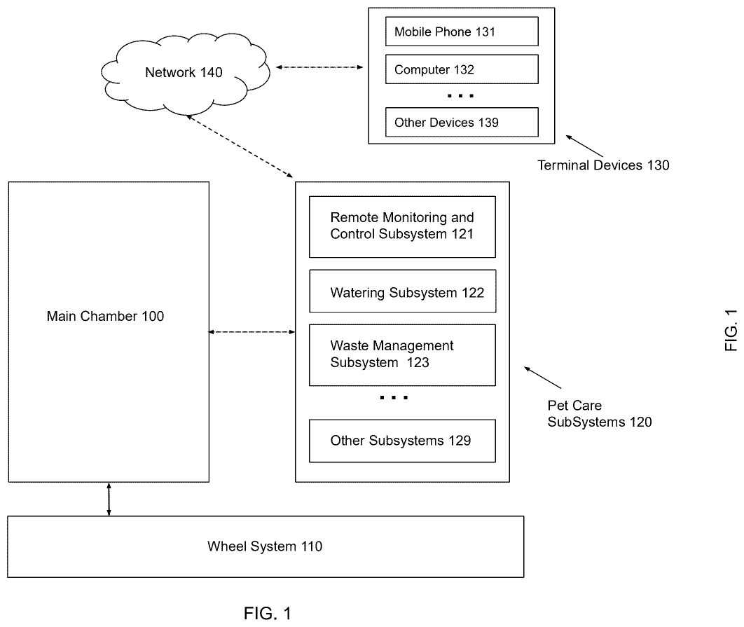

FIG. 1 provides a schematic diagram of the Mobile Autonomous Pet Care System according to one or more embodiments of the present invention. At the core of the system is Main Chamber 100, designed to house and support various Subsystems 120, which include, but are not limited to, a Remote Monitoring and Control System 121, a Watering System 122, and a Waste Management System 123, among Others 129 that may be incorporated as per specific pet care requirements. These subsystems are interconnected, as indicated by the dashed lines, and are capable of communication through Network 140, enabling remote interaction from Terminal Devices 130 such as Mobile Phone 131, Computer 132, and Other Devices 139. The entire assembly rests upon a Wheel System 110, granting the structure mobility for easy relocation as necessitated by environmental or operational conditions.

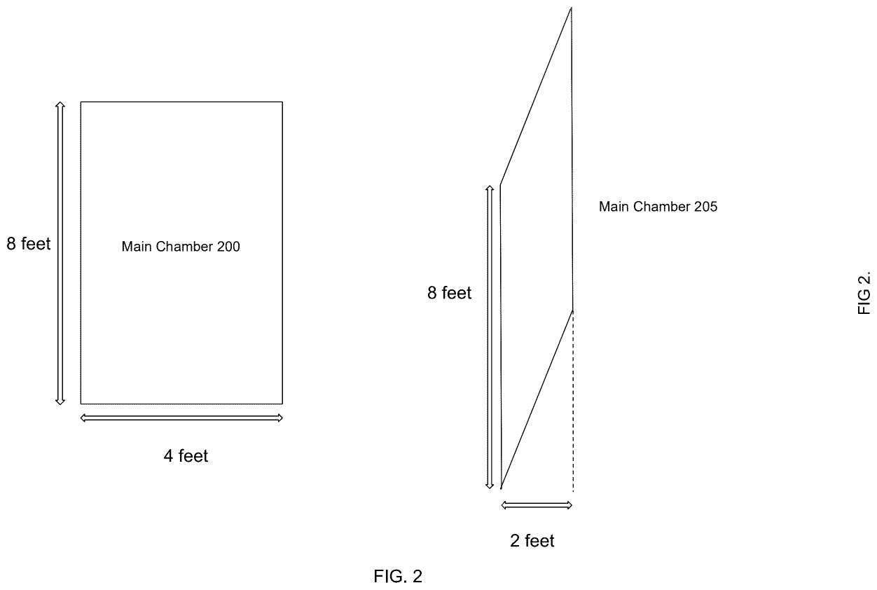

FIG. 2 illustrates an exemplary embodiment of the transformation of a main chamber from one configuration to another for ease of passage through various environmental constraints, in accordance with one or more embodiments of the present disclosure. As depicted, the main chamber 200, which is initially in a rectangular shape with dimensions of 8 feet by 4 feet, suitable for accommodating a large-sized dog, is reconfigurable into main chamber 205, a parallelogram-shaped structure with a width of 2 feet which is less than the width of a standard door. This modification allows the chamber to navigate through standard doors and narrow hallways, which are less than the width of the initial form. Main chamber 200 represents the chamber before transformation, and main chamber 205 illustrates the chamber after it has been adjusted to fit through narrower apertures, such as a standard door frame. This transformation is demonstrative of the main chamber's adjustable feature, designed to provide flexibility and adaptability in various spatial scenarios, thereby enhancing the mobility of the system.

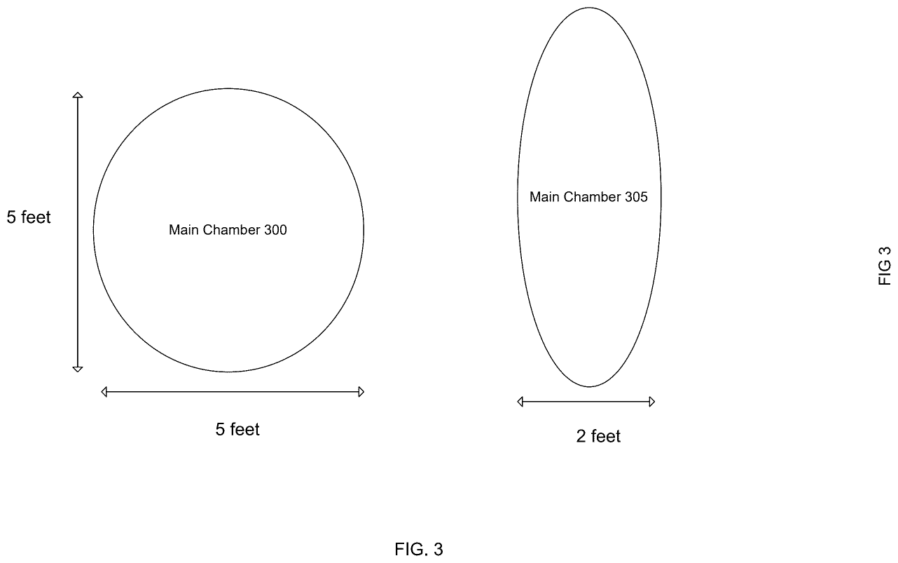

FIG. 3 demonstrates an additional exemplary embodiment of the main chamber's transformative capability, as per certain embodiments of the present disclosure. Displayed is a main chamber 300 initially configured as a circular structure with a diameter of 5 feet, which can be reconfigured into main chamber 305, an elliptical structure with a minor axis measuring 2 feet in width. This configuration change exemplifies the chamber's adaptability, allowing for the accommodation of a diverse range of spatial requirements.

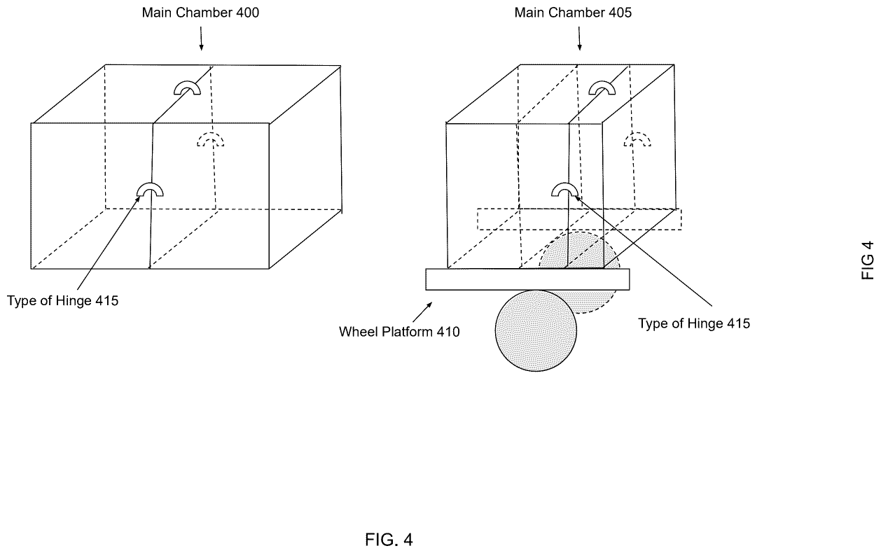

FIG. 4 illustrates a versatile Main Chamber 400 of the present invention, designed for size adjustability through the use of specialized hinges, Type of Hinge 415. Main Chamber 400 is composed of two halves that can be fully extended to maximize interior space for pet comfort when stationary, as shown on the left. For transport convenience on the Wheel Platform 410, as depicted on the right, the two halves of Main Chamber 405 can be reconfigured to nest within each other. This nesting capability is facilitated by Type of Hinge 415, allowing one half to slide into the other, effectively reducing the overall size of the chamber for ease of mobility. The retracted configuration demonstrates the invention's space-saving feature, enhancing the practicality of the pet care system during transit.

The present invention's main chamber is characterized by an array of structural adaptations that confer upon it an extraordinary level of spatial versatility. Envisioned within the scope of the invention is a main chamber with side panels engineered from materials that possess both rigidity and flexibility, allowing these panels to fold along pre-established lines, thereby reducing the dimensional breadth of the chamber for ease of movement through compact spaces, such as elevator interiors or constricted stairwells.

Further embodiments may incorporate a roof and base designed to retract or extend, altering the chamber's vertical dimension and ground area to facilitate transportation through areas with height restrictions or for efficient storage within limited spaces typical of vehicle trunks.

Additionally, the inventive concept extends to the incorporation of expandable sides made from elastic fabrics capable of extending to increase the internal volume of the chamber or retracting for a more streamlined form factor during transit.

The invention may also entail a modular sectional configuration of the main chamber, where individual modular elements can be disengaged and subsequently reassembled. This modular design allows for a customizable configuration of the chamber, tailored to the spatial limitations imposed by the travel environment.

In a further embodiment, the walls of the main chamber may be comprised of inflatable components, which can be deflated to permit the chamber to pass through tight openings and then re-inflated to reconstitute its original spacious form, thereby ensuring the pet's comfort is uncompromised.

The main chamber for pets can be made from a variety of materials depending on the intended use, budget, and desired durability.

The materials may include:
Wire mesh: Wire mesh is a popular material for pet main chamber because it is durable, lightweight, and provides good ventilation. It may be made from a variety of metals, including but not limited to steel, aluminum, or stainless steel.
Plastic: Plastic is another popular material for pet main chamber, particularly for smaller pets. Plastic offers a lightweight, cleanable, and cost-effective option for the main chamber, with the added benefit of being available in various colors and designs.
Wood: Wood is another candidate material, particularly for small type of pets. It provides a natural look and may be stained or painted to align with a range of decor styles.
Glass or Tempered Glass: Glass or Tempered Glass chamber are commonly used for pets that require a specific temperature and humidity range. Glass or Tempered Glass is also easy to clean and provides clear visibility of the interior space.
Metal: Metal is a durable and long-lasting material that is commonly used for exterior pet chamber such as dog kennels. It may be made from steel, aluminum, or other metals and may be powder-coated or painted for enhanced durability and visual appeal.

The main chamber serves as the primary housing for attaching various subsystems, including feeding system, watering system, waste management systems, and other systems. This Main Chamber is strategically devised to provide an efficient and centralized operation for these subsystems, simultaneously prioritizing the comfort and security of the pets housed within. The design of the Main Chamber facilitates a high degree of modularity, allowing for the subsystems to be swiftly attached or detached, thereby simplifying routine maintenance and enabling customization of the pet's living environment to the pet owner's preferences. This modular approach ensures the living space remains both versatile and adaptable, creating an optimal environment for pets to flourish in an orderly and sanitary setting.

By way of illustration, the Main Chamber may be outfitted with a water subsystem, which includes a water dispenser paired with a reservoir for water storage. This dispenser, affixed to the chamber's side, is designed with a user-friendly spout or nozzle from which the pet may drink comfortably. The associated water container is crafted for ease of removal, allowing for convenient refilling when necessary.

The invention contemplates various embodiments of water dispensers for attachment to the Main Chamber. These range from gravity-fed models, which supply water as the pet drinks, to automated types, engineered to replenish the water bowl upon reaching a low threshold. Certain advanced dispensers are also equipped with filtration units, ensuring the provision of clean, purified water, thereby safeguarding the pet from potential impurities.

### 2. Control and Monitoring System

The Main Chamber is complemented by a suite of Subsystem Modules, each meticulously engineered to augment the functionality of the pet care environment. These Subsystem modules associate to the main chamber for the pets and comprises the following subsystems:
Watering Subsystem: Ensures consistent hydration is available for the pet, employing mechanisms that can be tailored to meet the frequency and volume of the pet's water intake requirements.
Feeding Subsystem: Delivers precise portions of food at scheduled intervals, customizable to the dietary needs of the pet.
Waste Management Subsystem: Manages the pet's waste to maintain a hygienic living space, employing advanced disposal and cleaning technologies.
Temperature Control Subsystem: Regulates the environmental conditions within the Main Chamber, maintaining temperature parameters for optimal pet comfort and health.
Security Subsystem: Provides security measures to safeguard the pet, including but not limited to containment features and alert systems for unauthorized access.
Remote Monitoring and Control Subsystem: Enables the pet owner to monitor and interact with their pet remotely, ensuring peace of mind through continuous connectivity.
Exercise and Play Subsystem: Offers a variety of engagement and exercise options to ensure the pet remains active and stimulated.
Power Subsystem: Supplies and manages the power requirements of the Main Chamber and its associated subsystems, ensuring uninterrupted operation.
Other Subsystems

### 2.1. Watering Subsystem

The Watering Subsystem is a critical component of the Main Chamber, ingeniously designed to provide a reliable source of hydration for the pet. This subsystem is comprised of a reservoir for water storage, a pump or valve mechanism to regulate water flow, and an intricate network of tubing or piping to deliver water to designated areas within the chamber.

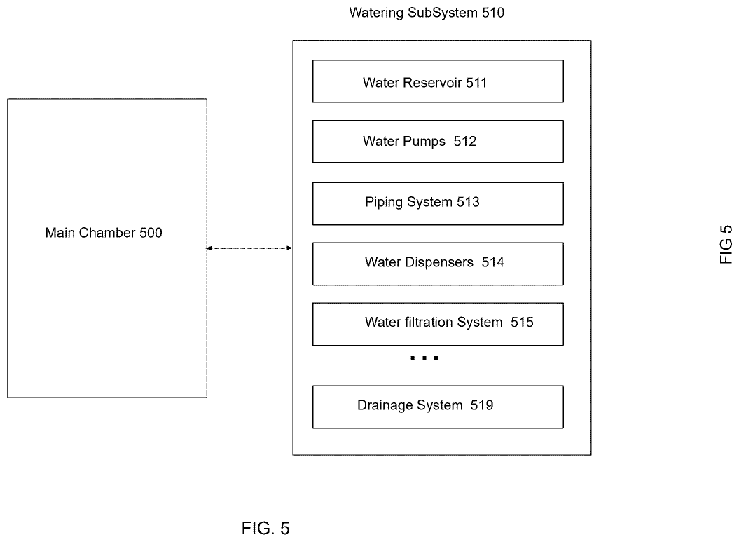

FIG. 5 delineates the Watering Subsystems 510 as an integral component of the Main Chamber 500 in accordance with the present invention. The subsystem is comprised of a series of interrelated modules designed to provide a comprehensive hydration solution for the pet. Central to this subsystem is the Water Reservoir 511, which serves as the primary source of water. Water Pumps 512 are utilized to regulate and facilitate the flow of water from the reservoir to the various dispensation points via the Piping System 513. Water Dispensers 514 are strategically positioned to offer accessible drinking points for the pet, and are supplied by the aforementioned piping network. Ensuring the purity of the water, the Water Filtration System 515 is incorporated to remove contaminants and impurities, thus maintaining the quality of water provided to the pet. To complete the subsystem, a Drainage System 519 is incorporated to efficiently manage and remove excess water, thereby sustaining a dry and hygienic environment within the Main Chamber 500.

The primary water source may take the form of a refillable container, such as a tank or bottle, which is seamlessly integrated with the pump or valve. This setup enables the precise routing of tubing or piping from the pump or valve to various dispensation points located throughout the Main Chamber. These points include, but are not limited to, feeding bowls, water dispensers, shower heads, misting systems, and integrated plumbing solutions.

The watering system may be designed to be automatic, with sensors and programmable timers that actuate the pump or valve to dispense water at specific intervals or in response to a reduction in water levels beneath a specified threshold.

Further refinement of the Watering Subsystem includes the implementation of a filtration system or water softeners, guaranteeing that the water provided is devoid of contaminants and bacteria, thereby safeguarding the pet's health.

To address water waste management, the subsystem incorporates a drainage solution, which could range from a simple floor drain to a more sophisticated setup involving a sloped surface or a collection tray. Such configurations may also include an auxiliary pump to expedite the removal of excess water, particularly post-showering activities.

Having a water subsystem attached to the main chamber of a pet cage is essential for ensuring that the pet has access to clean and fresh drinking water at all times. This design also minimizes the risk of spills or accidents, as the water is contained within the cage and does not require frequent refilling. The design of this subsystem prioritizes both convenience and cleanliness, facilitating ease of sanitation and hygiene maintenance within the pet's living quarters.

### 2.2. Feeding Subsystem

The Feeding Subsystem is an integral component of the comprehensive pet care solution provided by the Main Chamber, facilitating precise and reliable delivery of nourishment to the pet. This subsystem comprises a discrete container for storing pet food, which is connected to the dispensing unit via a system of tubing or piping.

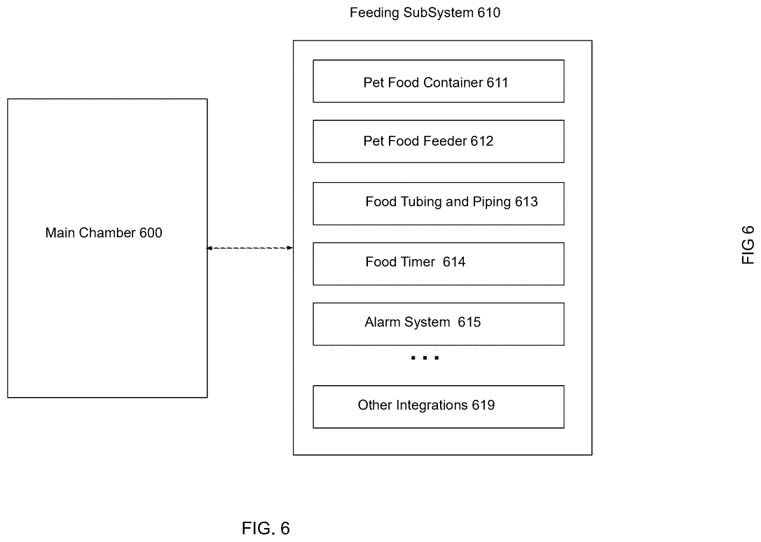

FIG. 6 presents a detailed schematic of the Feeding Subsystems 610 integrated within the Main Chamber 600, in accordance with various embodiments of the present invention. The subsystem is composed of several key components, including a Pet Food Container 611, which stores the pet's food supply, and a Pet Food Feeder 612, which precisely dispenses the food. The Food Tubing and Piping 613 are instrumental in transporting the food from the container to the feeder. A Food Timer 614 is integrated into the system to automate the feeding schedule, releasing food at predetermined times to regulate the pet's intake. An Alarm System 615 is also incorporated, designed to alert the owner to specific conditions such as low food supply or system malfunctions. The diagram also indicates the possibility for Other Integrations 619, which may include additional functionalities to enhance or complement the feeding process.

In one embodiment, the feeder is automated, incorporating programmable logic that enables the dispensation of predetermined food quantities at designated times, day or night. This automated process is governed by an internal clock mechanism or can be synced with external devices for precise timing. Such automation ensures that the pet's nutritional regimen is maintained consistently, irrespective of the owner's presence.

In an alternative embodiment, the feeder is manually operated, requiring the owner to initiate the feeding process through the engagement of a lever, button, or similar actuating device. This manual interaction allows for immediate control over the feeding cycle, catering to the changing needs of the pet.

The Feeding Subsystem is further enhanced by features like portion control and timing functions, which are instrumental in managing the pet's dietary intake. These features assist in preventing overfeeding and ensuring the pet receives the correct amount of nutrition.

In an exemplary embodiment of the Feeding Subsystem of the present invention, the automated delivery of alimentary provisions for a canine is precisely calibrated. The system is configured to apportion a predetermined quantity of sustenance, specifically one cup of canine nutritional fare, disbursed at two distinct temporal intervals within a twenty-four-hour cycle, namely at seven o'clock ante meridiem and six o'clock post meridiem respectively. The said subsystem comprises a reservoir for the storage of the canine comestibles and employs a programmable dispatch mechanism, which is actuated in accordance with an integrated chronometric module that governs the release of the nourishment.

Additionally, the subsystem is equipped with notification capabilities, which can alert the owner in the event of low food levels or operational malfunctions. These alerts can be configured to trigger alarms or send messages directly to the owner's smartphone, providing real-time updates on the subsystem's status.

For example, in a specific application of the Feeding Subsystem, an owner could program the automatic feeder to dispense half a cup of food every six hours, aligning with the pet's health and dietary requirements. Should the food reservoir approach depletion or should a malfunction impede the scheduled feeding, the system would promptly notify the owner via their connected device, allowing for immediate remedial action. This level of monitoring and control exemplifies the Feeding Subsystem's role in ensuring the pet's well-being through meticulous nutritional management.

### 2.3. Waste Management Subsystem

The Waste Management Subsystem is a critical component designed for integration with the Main Chamber, offering a hygienic solution for the pet's waste disposal. A waste management system that may be easily attached or detached from a main chamber may consists of several components, including a waste collection tray, a drainage system, and a fastening mechanism.

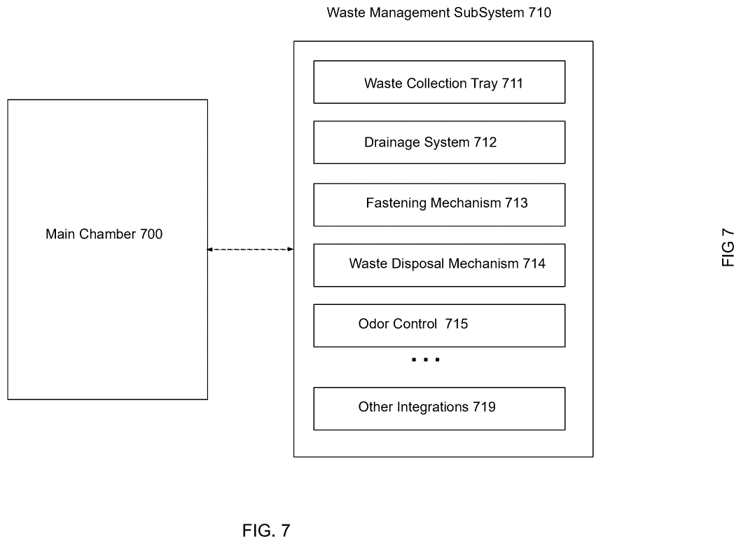

FIG. 7 delineates the Waste Management Subsystem 710, an integral part of the Main Chamber 700, designed to streamline the sanitation process within the pet care system. At the forefront is the Waste Collection Tray 711, engineered to be positioned directly beneath the Main Chamber 700, functioning as a receptacle for the pet's waste. The Drainage System 712 is a carefully designed network that efficiently directs the waste from the tray to an appropriate disposal site, which could be a communal sewage system or a contained holding tank. A pivotal component in securing the Waste Management Subsystem 710 to the Main Chamber 700 is the Fastening Mechanism 713. Other Integrations 719 suggest the potential for incorporating additional features.

The waste collection tray is designed to fit underneath the main chamber and collect any waste that is produced by the pet. It may be made of plastic or other durable materials and may have a non-stick surface to facilitate straightforward cleaning and maintenance.

The subsystem is also equipped with a comprehensive drainage system, responsible for channeling waste away from the collection tray to an appropriate waste disposal point, which could be a domestic sewage system, septic system, or a designated holding tank for subsequent disposal. This system may encompass an assembly of pipes, hoses, or connectors and could integrate a filtering mechanism to mitigate odors and prevent blockages within the system.

The fastening mechanism is used to securely attach the waste management system to the main chamber. It may consist of a series of hooks, clips, or other types of fasteners that may be easily attached or detached as needed.

The subsystem comprises a waste tray or container, a disposal mechanism, and a mechanism to control odors. The waste tray or container is placed at the bottom of the main chamber and is designed to collect any urine or feces. Some waste trays or containers can be removable for easy cleaning or disposal. The disposal mechanism can be a simple mechanism to dump the waste into a garbage may or more complex, such as an automatic flushing system that sends the waste directly to a sewage or septic system. The subsystem can come with features to control odors, such as filters or deodorizers that help to neutralize and diminish unpleasant smells.

The subsystem may include a self-cleaning litter box or a designated potty area to keep the pet's living space clean and hygienic.

### 2.4. Temperature Control Subsystem

The Temperature Control Subsystem is a sophisticated assembly within the Main Chamber, meticulously designed to create an optimal climate controlled environment for the pet. The subsystem comprises a thermostat, a dual-function heating or cooling unit, and a set of sensors to monitor the temperature.

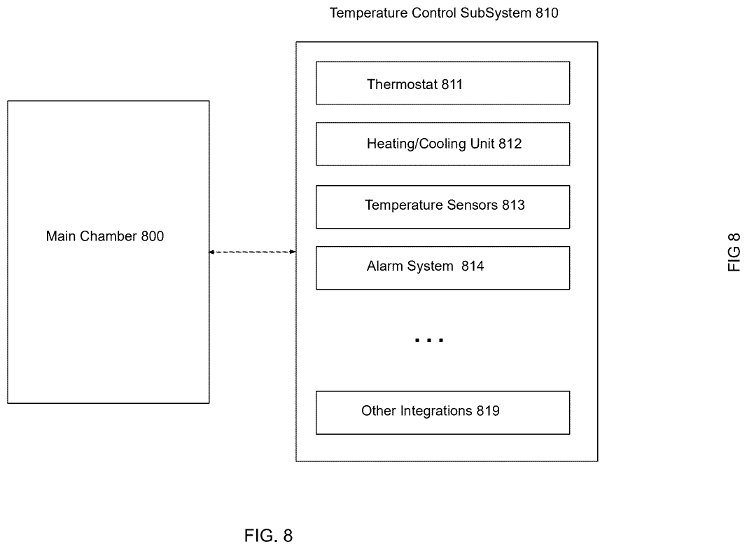

FIG. 8 illustrates the Temperature Control Subsystems 810, which are integral to maintaining an ideal climate within Main Chamber 800 of the present invention. This subsystem encompasses a Thermostat 811, which acts as the primary regulatory component, programmed to sustain the chamber within a specific temperature range suited to the pet's comfort and health. Attached to the Main Chamber 800, the Heating/Cooling Unit 812 is responsible for modulating the internal atmosphere. Temperature Sensors 813 are strategically placed to provide continuous feedback on the internal conditions of the chamber. An Alarm System 814 is integrated into the subsystem, designed to issue notifications or warnings to the pet owner should the temperature veer outside the pre-set limits. Other Integrations 819 suggest the potential for incorporating additional features.

The thermostat acts as the central command unit tasked with maintaining the chamber within a predefined temperature range tailored to the pet's specific requirements. The thermostat is programmable, ensuring the ambient temperature is consistently regulated according to the pet's needs for warmth or coolness.

The heating or cooling unit is responsible for adjusting the temperature in the main chamber to the desired level. In instances where the chamber's environment falls below the ideal temperature, the heating mechanism is activated to infuse warmth. Conversely, should the internal climate exceed the optimal threshold, the cooling function is engaged to lower the temperature, thereby safeguarding the pet against temperature extremes.

The temperature control system may also come with sensors to monitor the temperature in the main chamber and provide feedback to the thermostat. This allows the thermostat to adjust the temperature more accurately, based on real-time conditions in the chamber.

A critical feature of the Temperature Control Subsystem is its capacity to communicate with the pet owner. In the event that the internal temperature deviates beyond the set operational parameters, the subsystem is equipped to issue alerts. These notifications, which may take the form of alarms or messages sent directly to the owner's smartphone, act as an immediate prompt for the owner to intervene if necessary, ensuring the pet's environment remains safe and comfortable at all times.

### 2.5. Security and Monitoring Subsystem

The Security and Monitoring Subsystem is designed to provide comprehensive surveillance and ensure the safety of the pet. The subsystem comprises cameras, sensors, alarms, a control unit and other communication means (such as wireless transmit and receive unit).

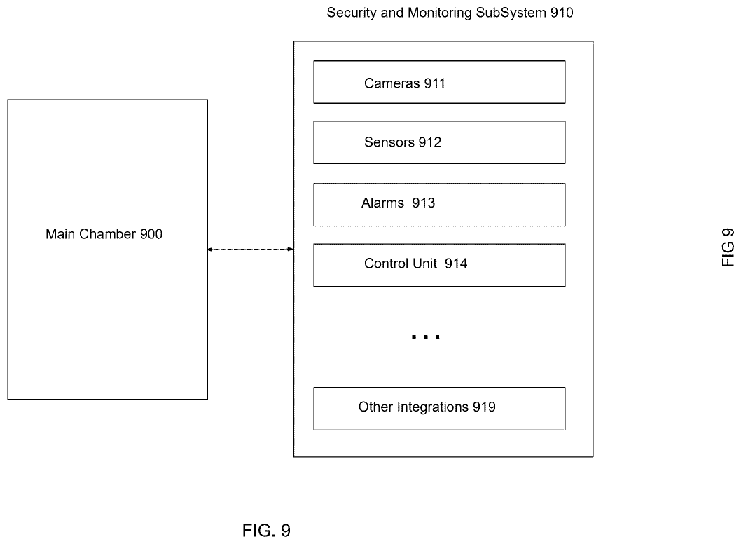

FIG. 9 illustrates the Security and Monitoring Subsystem 910, which are adeptly integrated with the Main Chamber 900 to provide a secure and observable environment for the pet. This subsystem includes Cameras 911, positioned to offer comprehensive visual coverage of the chamber's interior and exterior, capturing any unusual activity or presence. Sensors 912, forming a crucial part of the security matrix, are strategically placed to detect a range of environmental parameters and movements, triggering responsive actions such as the activation of Alarms 913 when anomalies are detected. The Control Unit 914 serves as the command center for the subsystem, processing input from the cameras and sensors to manage the operational response. The subsystem is designed with the capacity for Other Integrations 919, which may encompass additional security features or technologies.

The cameras and sensors may be placed around the main chamber to detect any unusual activity or movement, such as an intruder or unauthorized access to the chamber. These devices are calibrated to activate an alarm and initiate recording upon detecting anomalous movements or breaches. They also possess the capability to send immediate notifications to the pet owner or a designated security service, ensuring that any security incident is promptly addressed.

The sensors, which are attuned to a spectrum of environmental variables such as temperature, humidity, air quality, and motion, are configured to dispatch alerts when environmental conditions deviate from the established safe ranges. For instance, if the interior temperature escalates beyond a pre-set level, or unexpected motion is detected within the chamber, the system will trigger an alert to notify the pet owner.

Cameras are installed both within and outside the Main Chamber, offering real-time visual oversight of the pet and its surroundings. This allows pet owners to access live video streams or recorded footage remotely, providing peace of mind and enabling them to check on their pet's well-being at any time.

The control unit, which forms the nucleus of the subsystem, is programmable and can be set to respond to sensor inputs by engaging the alarm or notification systems. It can also be directed to perform additional security actions, such as securing the chamber's access points and locking the windows.

The communication system can be used to send alerts or notifications to the pet owner's mobile device or computer. It also enables remote operation of the Main Chamber's amenities. This includes adjustments to environmental controls, activation of lighting, and the management of automated feeding and watering mechanisms.

### 2.6. Remote Monitoring and Control Subsystem

The Remote Monitoring and Control Subsystem provids pet owners with the ability to supervise and interact with their pets from afar. The system facilitates remote observation through a mobile application or a web interface, granting real-time video streaming and instant alerts to the owner for any unusual pet activity or environmental changes within the Main Chamber.

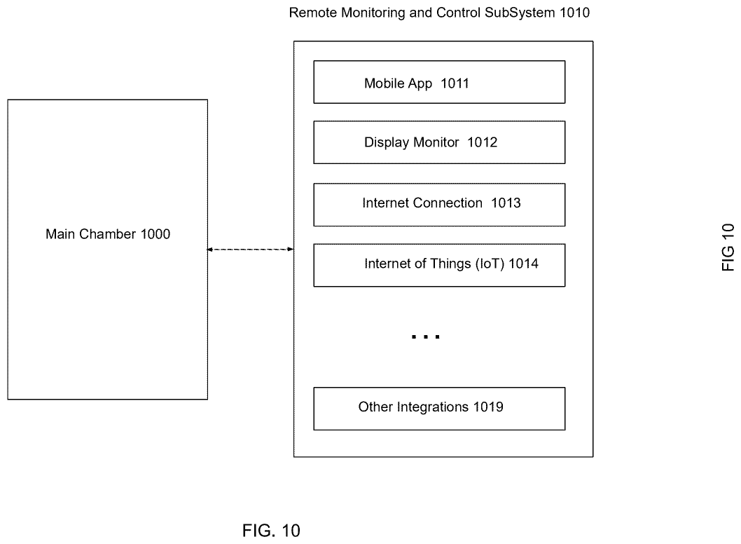

FIG. 10 portrays the Remote Monitoring and Control Subsystem 1010, seamlessly integrated into the Main Chamber 1000. This subsystem features a Mobile App 1011, which serves as the interface for real-time interaction, monitoring, and management of the pet's environment. The Display Monitor 1012 within the Main Chamber 1000 allows for the display of images or videos to comfort the pet with the owner's presence. It can also interface with the Mobile App 1011 to provide visual communication or entertainment for the pet. The Internet Connection 1013, which facilitates the connectivity of the Main Chamber 1000 to the global network. The Internet of Things (IoT) 1014 capability indicates the system's smart integration into a network of interconnected devices. Other Integrations 1019 suggest the potential for additional functionalities that could be added to the subsystem.

The subsystem's capability extends to emotional support for pets through a display capable of showing the owner's image or video, and speakers that play the owner's voice or music, creating a comforting auditory backdrop. These features help to mimic the owner's presence, alleviating the stress pets might experience in their absence.

The system's connectivity enables interaction with a broader array of services and devices. Through the Internet of Things (IoT), the subsystem can interface with smart home systems, allowing for the orchestration of various chamber functions such as temperature adjustments, lighting, and even the activation of interactive toys from any location.

The system's online connectivity means it can integrate with external services such as veterinary telehealth, allowing pet health professionals to remotely observe and assess the pet's well-being, providing advice or alerting owners to any concerns. Integration with e-commerce platforms could facilitate the automatic replenishment of pet supplies when sensors indicate low food or water levels. The internet-enabled system can promptly notify owners of any security issues within the chamber, employing various protocols to ensure pet safety. Owners can respond to these alerts immediately, whether by soothing their pet through the speakers or by securing the chamber via remote locking mechanisms.

The subsystem gives owners unparalleled control with the ability to remotely fine-tune their pet's environment, from adjusting feeding schedules to controlling the playtime music playlist, all contributing to a tailored and nurturing habitat for their pets. This level of personalization is only possible through the subsystem's intelligent design, which actively learns the pet's habits and preferences to anticipate needs and adjust settings accordingly.

### 2.7. Exercise and Play Subsystem

The Exercise and Play Subsystem is an intricately designed component of the Main Chamber, tailored to cater to the intrinsic playfulness and physical needs of pets. The subsystem comprises various toys, equipments, and obstacles that provide physical activity and mental stimulation for the pet.

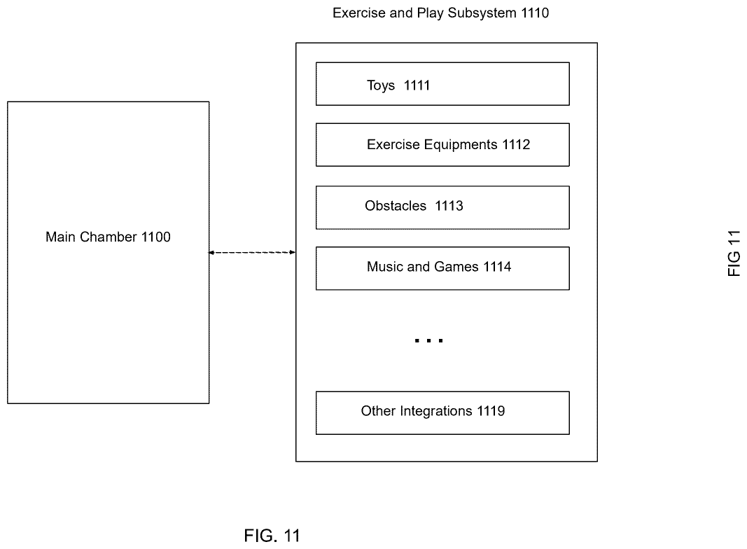

FIG. 11 outlines the Exercise and Play Subsystem 1110, a dynamic and interactive component of the Main Chamber 1100. The Toys 1111, including items such as balls, chew toys, and puzzle toys, are selected to cater to the innate play instincts of the pet, promoting engagement and preventing boredom. Exercise Equipment 1112, which could range from treadmills to climbing structures, is provided to encourage physical activity, vital for the pet's health and well-being. Obstacles 1113 are purposefully included to enrich the pet's environment, offering challenges that enhance agility and coordination. The subsystem integrates Music and Games 1114, which can include auditory stimulation or interactive digital games that react to the pet's movements or actions, providing a multisensory experience. Other Integrations 1119 suggest the potential for incorporating additional features.

The subsystem includes toys such as balls, chew toys, and puzzle toys that may keep the pet entertained and engaged. Each toy is selected with consideration for the pet's individual play preferences and safety, ensuring that they are made from non-toxic, durable materials appropriate for the pet's size and strength.

For pets requiring more vigorous activity, the subsystem may include specialized exercise equipment such as treadmills tailored for pets or climbing walls designed to enhance their natural climbing instincts. These pieces of equipment are instrumental in promoting the pet's physical well-being, aiding in weight management, and providing an outlet for excess energy.

Obstacles such as tunnels, ramps, and jumps may be included to create a fun and challenging environment for the pet to play in. These obstacles are able to help to improve the pet's agility and coordination, while also providing mental stimulation.

In addition to physical equipment, the subsystem may include features such as music or interactive games that the pet may enjoy. For example, a pet may enjoy playing with a toy that emits sounds or lights up in response to its actions.

The subsystem may be controlled by the pet owner or automated to provide exercise and entertainment for the pet when the owner is away. For example, a ball launcher may be programmed to throw a ball at regular intervals, or a treat dispenser may be used to reward the pet for playing with a specific toy or completing an obstacle course.

The integration of the exercise and play subsystem attached to the main chamber for a pet may provide several benefits, such as keeping the pet physically and mentally stimulated, improving its overall health and well-being, and reducing boredom and destructive behavior.

### 2.8 Power Subsystem

The Power Subsystem delivers essential power to support all related sub-systems, with options for both renewable and conventional energy sources. The subsystem may be battery or plugged-in powered. The subsystem may be attached to the main chamber for pets to provide a reliable and sustainable source of power.

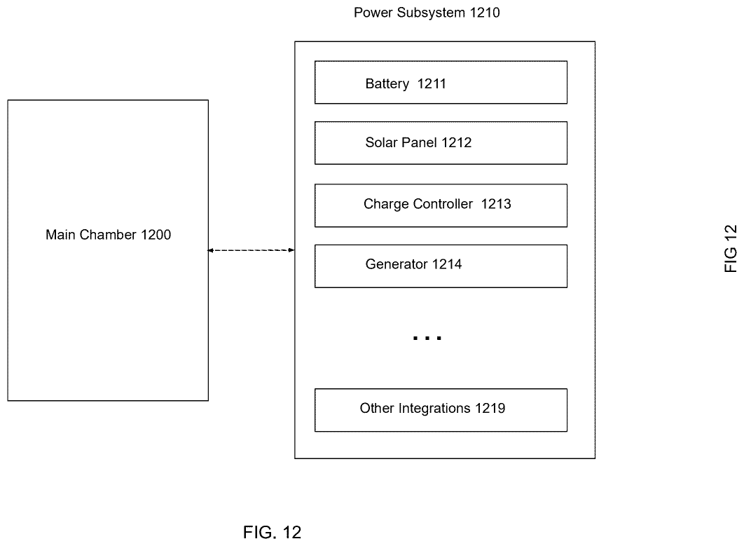

FIG. 12 displays the Power Subsystem 1210 associated with the Main Chamber 1200, equipped to provide continuous energy supply. This subsystem integrates a battery 1211 for energy storage, solar panels 1212 for harnessing renewable energy, a charge controller 1213 to manage the energy flow, and a generator 1214 for additional power backup. Additionally, it incorporates other integrations 1219 for expanded functionality, ensuring the subsystem's adaptability and resilience in meeting the Main Chamber's power demands.

This system may includes the following components:
Battery: The battery stores the electricity generated by the solar panel or charged by the plug-in charging methods and powers the various sub-systems of the pet care systems, such as lighting, ventilation, and temperature control.
Solar Panel: The solar panel is responsible for converting sunlight into electricity. The solar panels may be a flexible or rigid panel. Depending on design preferences and spatial constraints, these panels can be flexible or rigid, and are strategically placed to harness optimal sunlight.
Charge Controller: The charge controller regulates the flow of electricity from the solar panel to the battery to prevent overcharging or damage to the battery.
Inverter: The inverter is responsible for converting direct current (DC) from the battery to alternating current (AC), the standard required for most household devices and appliances within the pet care system.
Generator: For additional reliability, a generator can be incorporated as a backup power source. In the event of solar insufficiency or battery depletion, the generator can provide an immediate supplementary power supply, ensuring no interruption to the system's operations.
Energy Monitoring System: The monitoring system allows the pet owner to track the performance of the solar panel, battery, and charging controller. It may be a digital display, a mobile app, or a web-based interface that allows the pet owner to view data and adjust settings remotely.

The Power Subsystem is engineered to prioritize continuity of care, allowing for seamless transition between power sources as needed. By including a variety of power generation and storage options, the system guarantees that the pet's environment remains consistently powered, controlled, and comfortable, regardless of external power conditions or the owner's presence.

### 3.2 Wheel Platform

A wheel platform that may be used to move the main chamber between indoor and outdoor areas through entryways such as standard doors comprises a sturdy frame, wheels, and a locking mechanism.

The frame is designed to fit onto the bottom of the main chamber, and may be attached using screws, bolts, or other fasteners. The frame is designed to securely hold the main chamber, and may be made of metal or other durable materials. The frame may also have adjustable components to ensure a secure fit for different types of main chambers.

The set of wheels is designed to be easily attached or detached from the frame, and may be secured in place using a locking mechanism or other type of fastener. The wheels may be made of rubber or other durable materials to ensure a smooth and reliable ride, and may be designed to swivel or turn for easier maneuverability. The wheels are designed to be large enough to easily move the main chamber over various surfaces, such as carpet, tile, grass-field or concrete.

The locking mechanism is used to keep the main chamber securely in place during transport, and to prevent it from rolling away when unattended. It may consist of a brake or lock that may be engaged or disengaged by the pet owner.

The wheel platform may also include other features, such as adjustable handles or a foldable design for easier storage and transport. The wheel platform may be used with different types of main chambers, such as those for pets of different sizes or with different subsystems attached.

The platform's surface may be covered with a layer of cushioning material, such as foam or rubber padding, or with a layer of spring system, to absorb shock and prevent the chamber from sliding around during transport. The cushioning material is specifically designed to reduce the impact of bumps and vibrations that can occur during transport, which can be especially important if the pets are sensitive or easily stressed. The cushioning material may be covered with a non-slip surface, such as textured rubber or fabric, to provide additional stability for the chamber.

Using a wheel platform to move the main chamber between indoor and outdoor areas may be beneficial for pets that need access to fresh air and sunlight, or for pet owners who want to provide their pets with a change of environment. It may be useful for cleaning or maintenance tasks, as the main chamber may be easily moved to a location where it may be easily cleaned or serviced.

The Wheel Platform's utility extends beyond mere transportation; it can be anchored to the ground for stability when parked in diverse settings such as campsites, front or inside garages, parks, and more. This anchoring capability ensures safety and immobility, providing a reliable and static environment for the Main Chamber wherever it may be located. Whether for accessing fresh air and sunlight, or for facilitating routine cleaning and maintenance, the Wheel Platform significantly enhances the versatility and functionality of the Mobile Autonomous Pet Care System.

The wheel platform augments the versatility of the adjustable Main Chamber, allowing for its smooth transportation and secure placement in a variety of settings, such as a friend's garage, outside a relative's house, or on a lawn. This attribute allows for seamless transition of pet care responsibilities and proves especially advantageous for pet owners in need of temporary care solutions, offering a straightforward and hassle-free method to guarantee their pets are well-cared for during periods of absence.

The ability to drive and park the Main Chamber at a friend's garage allows for seamless transition of pet care responsibilities, ensuring that pets remain in a controlled and familiar environment, even away from their primary home

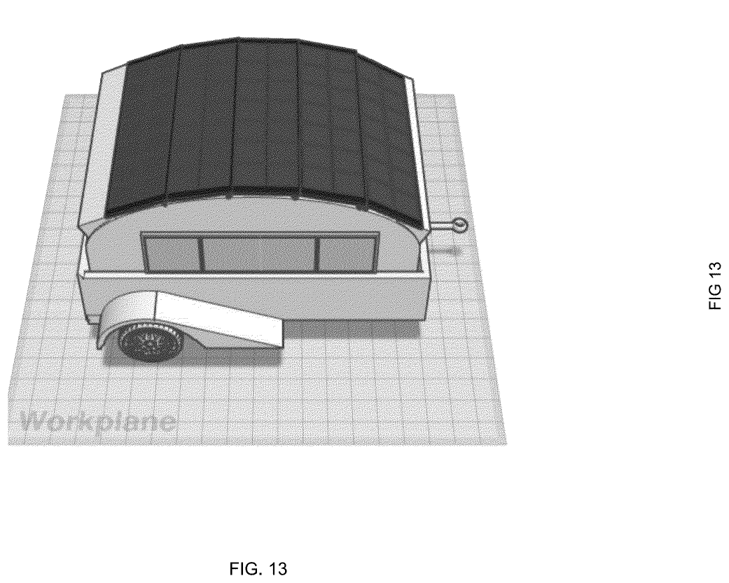

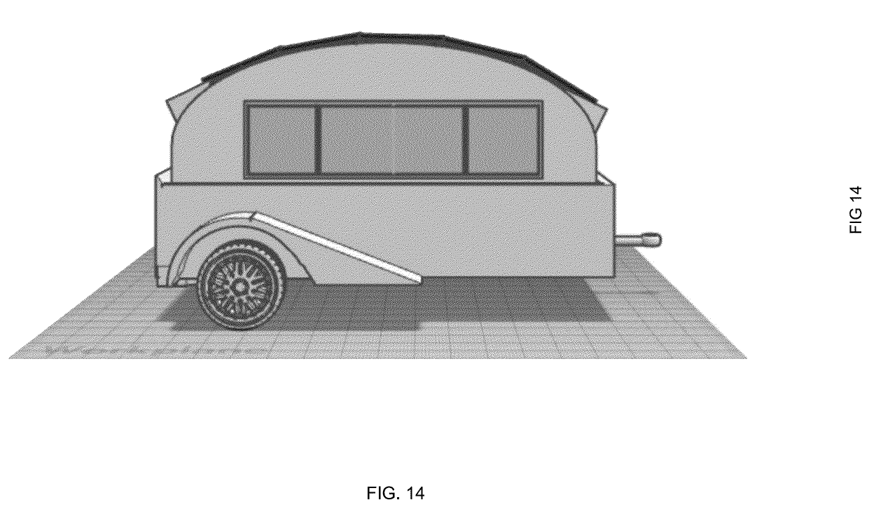

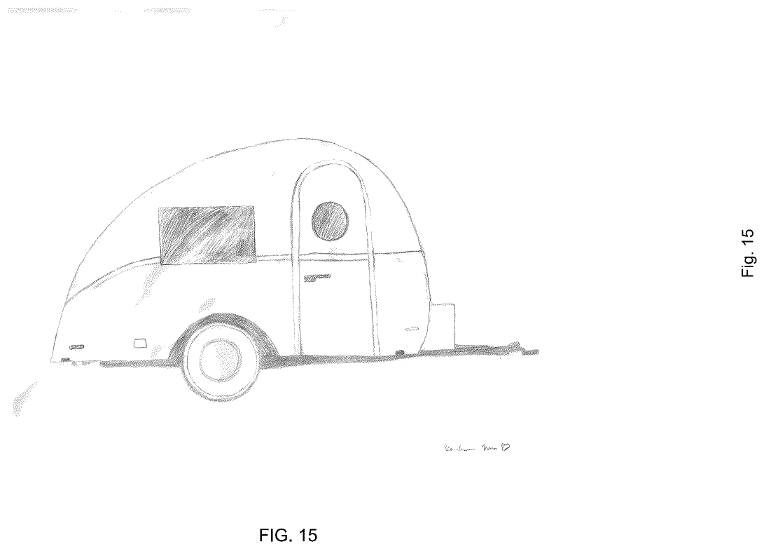

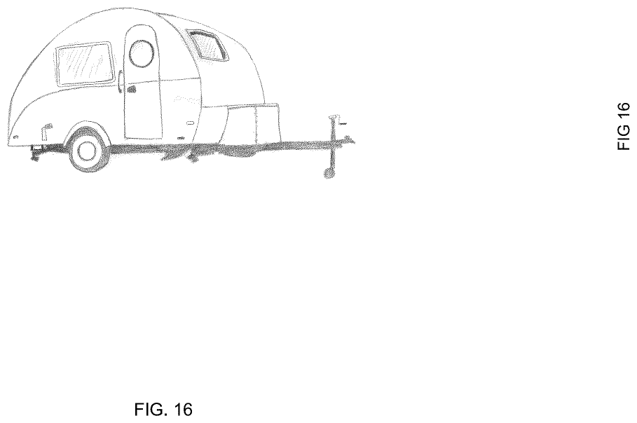

The exemplified drawings, FIG. 13 through FIG. 16, illustrate various embodiments of the Mobile Autonomous Pet Care System attached to a Wheel Platform.

1. A Mobile Autonomous Pet Care System, comprising:
an adjustable Main Chamber whose dimensions and shape are configurable to accommodate pets of various sizes and to facilitate seamless passage through different-sized entryways, wherein the Main Chamber's adjustments allow for alterations in both size and geometric configuration to ensure compatibility with a range of indoor and outdoor environments;
a plurality of modular supporting subsystems detachably coupled to the Main Chamber, each subsystem designed to fulfill specific pet care functions comprising: watering, feeding, waste management, temperature control, exercise and play, security and remote monitoring and control;
wherein the adjustable Main Chamber, capable of altering its shape and dimensions, and the modular pet care subsystems are integrated into a cohesive operational framework to provide a comprehensive and autonomous care solution for pets.

2. The Mobile Autonomous Pet Care System of claim 1, wherein the adjustable Main Chamber is specifically designed to modify its shape and size to facilitate passage through standard household doors, enhancing the system's mobility between indoor and outdoor environments without manual disassembly.

3. The Mobile Autonomous Pet Care System of claim 1, wherein the adjustable Main Chamber is equipped with a mechanism for manual or automated adjustment of its dimensions and shape, facilitating customization to meet the specific needs of the pet and the space it occupies.

4. The Mobile Autonomous Pet Care System of claim 1, wherein the adjustable Main Chamber, initially exemplified by dimensions of 4 feet by 6 feet with a square configuration, is capable of altering its shape to a parallelogram to facilitate passage through a doorway measuring 3 feet in width, showcasing the system's dynamic adaptability in reconfiguring its geometric structure to navigate constrained spaces.

5. The Mobile Autonomous Pet Care System of claim 1, wherein the Watering Subsystem includes a filtration system to ensure the provision of clean and fresh water to the pet, and a monitoring system to alert the owner when water levels are low.

6. The Mobile Autonomous Pet Care System of claim 1, wherein the Feeding Subsystem comprises an automated feeder capable of dispensing predetermined quantities of food at scheduled intervals, and includes sensors to notify the owner when food supplies need replenishment.

7. The Mobile Autonomous Pet Care System of claim 1, wherein the Waste Management Subsystem features an automated cleaning mechanism to regularly dispose of waste, and contains odor control technology to maintain a hygienic environment within the Main Chamber.

8. The Mobile Autonomous Pet Care System of claim 1, wherein the Temperature Control Subsystem utilizes environmental sensors to monitor and adjust the internal conditions of the Main Chamber, maintaining an optimal climate for the pet's health and comfort.

9. The Mobile Autonomous Pet Care System of claim 1, wherein the Exercise and Play Subsystem includes interactive toys and exercise equipment that can be remotely activated or programmed to engage the pet in physical activity.

10. The Mobile Autonomous Pet Care System of claim 1, wherein the Security Subsystem safeguards the pet by detecting and notifying owners of unauthorized access or potential security breaches within the environment of the Main Chamber.

11. The Mobile Autonomous Pet Care System of claim 1, wherein the Remote Monitoring and Control Subsystem provides real-time video surveillance of the pet, and allows the owner to remotely control system settings and receive alerts on the pet's wellbeing.

12. The Mobile Autonomous Pet Care System of claim 1, wherein the adjustable Main Chamber's size and shape can be modified either manually or remotely, with the latter operation facilitated through a remote control mechanism integrated within the Remote Monitoring and Control Subsystem, allowing pet owners to reconfigure the chamber's dimensions and geometric structure from a distance to suit immediate spatial requirements or preferences.

13. The Mobile Autonomous Pet Care System of claim 1, wherein the modular supporting subsystems are interconnected through a centralized control unit, enabling synchronized operation and remote management by the pet owner via a mobile application or web interface.

14. The Mobile Autonomous Pet Care System of claim 1, wherein the Power Subsystem that ensures a sustainable energy supply for the system's operation, capable of integrating and managing power from multiple sources including solar panels, batteries, and generators, to maintain continuous functionality of the Main Chamber and its modular supporting subsystems.

15. The Mobile Autonomous Pet Care System of claim 1, further comprising a Wheel Platform integrated with the Main Chamber, featuring a locking mechanism for secure placement and wheels designed for easy maneuverability across various terrains, facilitating the transport of the Main Chamber between locations.

16. The Mobile Autonomous Pet Care System of claim 1, wherein the Wheel Platform is specifically engineered to effortlessly roll the Main Chamber up and down, facilitating smooth transitions between varying elevations, and is additionally designed for easy disassembly for compact storage, underscoring the system's convenience and adaptability to diverse environmental contexts.

17. The Mobile Autonomous Pet Care System of claim 1, wherein the adjustable Main Chamber is constructed for transportability and stationing in various locations, such as private garages, exterior residential areas, or communal outdoor spaces, thereby enabling a versatile arrangement for temporary caregiving by designated individuals. This configuration ensures that pets can be efficiently and comfortably managed in the owner's absence, promoting seamless continuity of care and welfare.

18. A Mobile Autonomous Pet Care System comprising:
an adjustable Main Chamber configured to accommodate pets of varying sizes and to facilitate passage through variously sized entryways;
a modular subsystem framework including but not limited to a Watering Subsystem, a Feeding Subsystem, a Waste Management Subsystem, a Temperature Control Subsystem, a Security and Monitoring Subsystem, and a Remote Monitoring and Control Subsystem;
c. an integrated Power Subsystem capable of drawing energy from multiple sources including a battery, solar panels, and a generator;
d. a Wheel Platform affixed to the Main Chamber, featuring a sturdy frame with a locking mechanism and wheels designed for traversability across diverse surfaces;
e. the subsystem framework being further characterized by components for engagement and stimulation, including interactive toys, exercise equipment, and environmental obstacles within an Exercise and Play Subsystem;
f. wherein the Main Chamber and its subsystems are constructed to facilitate a controlled, interactive, and adaptable living environment for the pet.
